(19) United States
(12) Patent Application Publication
(10) Pub. No.: US 2021/0379431 A1
(43) Pub. Date: Dec. 9, 2021

(54) AUTONOMOUS FIREFIGHTING SYSTEM & METHOD

(71) Applicant: Yuen Mao, San Diego, CA (US)

(72) Inventor: Yuen Mao, San Diego, CA (US)

(21) Appl. No.: 17/327,399

(22) Filed: May 21, 2021

Related U.S. Application Data
(60) Provisional application No. 63/036,376, filed on Jun. 8, 2020.

(51) Int. Cl. A62C 3/02; G05D 1/10

(52) U.S. Cl. CPC A62C 3/0271; G05D 1/104; A62C 3/0242

(57) ABSTRACT

An autonomous firefighting system is disclosed. The autonomous firefighting system may include a controller coupled to one or more unmanned aircraft, one or more unmanned vehicles, one or more valves of a water spraying system, or a combination thereof, and further coupled to one or more fire-associated risk surveillance assets (FARSAs). The controller utilizes the FARSA(s) to detect a fire-associated risk event, which may include an active or potential fire event, and subsequently creates and delivers instructions to the one or more unmanned aircraft, one or more unmanned vehicles, one or more valves of a water spraying system, or combination thereof for mitigating damage associated with the actual or potential fire-associated risk event.

### CROSS-REFERENCE TO RELATED APPLICATIONS

This application claims benefit of priority with U.S. Provisional Application Ser. No. 63/036,376, filed Jun. 8, 2020; the entire contents of which are hereby incorporated by reference

### BACKGROUND

### Field of the Invention

The invention relates to firefighting systems, and more particularly, to an autonomous firefighting system embodying one or more unmanned aircraft, vehicles, and/or a water spraying system, one or more fire-associated risk surveillance assets, and a controller configured to detect fire-associated risk events and deploy the one or more unmanned aircraft and/or water spraying system for mitigating actual or potential damage associated with the detected fire-associated risk events.

### Description of the Related Art

Wildfires have become especially prevalent in states like California where minimal rain and large areas of dry land can create massive fires which destroy property and the environment. Sizes of such wildfires have increasingly gotten worse and are the cause of billions of dollars in damages every year. A seemingly small spark or fire can grow into a much larger fire in little time given the annual dry conditions.

Recently, fire departments have begun using newer technologies, such as drones, to assist in combating such fires. Drones have been used for aerial mapping, indicating a hottest part of the fire, and even identifying if people are in danger. In such a way, drones are being used to assist fire departments in a reactive manner after the fire is out of control. Even utility companies are utilizing drones to survey areas of potential danger. However, these drones are not used beyond mere inspection and any actual response given to the areas of potential danger is still conducted manually where precious time may be lost.

There is a need for an autonomous firefighting system which detects and mitigates active or potential fire events in an efficient manner, before the active or potential fire event becomes uncontrollable.

### SUMMARY

In each of several embodiments, an autonomous firefighting system is described, the autonomous firefighting system may include a controller coupled to one or more unmanned aircraft, one or more unmanned vehicles, one or more valves of a water spraying system, or a combination thereof, and further coupled to one or more fire-associated risk surveillance assets (FARSAs). The controller utilizes the FARSA(s) to detect a fire-associated risk event, which may include an active or potential fire event, and subsequently creates and delivers instructions to the one or more unmanned aircraft, one or more unmanned vehicles, one or more valves of a water spraying system, or combination thereof for mitigating damage associated with the actual or potential fire-associated risk event.

### BRIEF DESCRIPTION OF THE DRAWINGS

FIG. 1 shows a block diagram representation of an autonomous firefighting system in accordance with a first illustrated embodiment;

FIG. 2 shows an autonomous firefighting system in accordance with a second illustrated embodiment;

FIG. 3 shows an autonomous firefighting system in accordance with a third illustrated embodiment; and

FIG. 4 shows an autonomous firefighting system in accordance with a fourth illustrated embodiment.

### DETAILED DESCRIPTION OF EMBODIMENTS

In various embodiments, an autonomous firefighting system is disclosed, the autonomous firefighting system is configured to monitor a subject area or infrastructure for fire-associated risk events, and upon detection thereof, the autonomous firefighting system is configured to deploy one or more unmanned aircraft or other fire-mitigating assets for mitigating damage associated with actual or potential fire events.

### Definitions

For purposes herein, “autonomous firefighting system” means a system embodying one or more fire-mitigating assets, one or more fire-associated risk surveillance assets, and a controller configured to detect fire-associated risk events and deploy the one or more fire-mitigating assets for mitigating actual or potential damage associated with each of the detected fire-associated risk events;

“controller” means a hardware device or a software program that manages or directs the flow of data between two entities, namely, between one or more fire-associated risk surveillance assets and a command center, between a command center and a fire-mitigating asset, between a fire-associated risk surveillance asset and a fire-mitigating asset, or any combination thereof;

“fire-associated risk event” means any event, the occurrence of which presenting an increased risk of fire;

“fire-associated risk surveillance asset (FARSA)” means any sensor or other component configured to detect fire, temperature, or to detect debris for which relatively high risk of fire is associated, and may include, without limitation: power line-based sensors and remote-based sensors, such as, for example, temperature sensors, wire tension sensors, ice costing sensors, tension clamp sensors, weather sensors, cameras including but not limited to thermal imaging cameras, smoke sensors, infrared sensors, and the like;

“fire-mitigating asset” means any unmanned aircraft, unmanned vehicle, or water spraying system configured to extinguish or substantially reduce the spread of fire;

“fire-mitigating drone” means an unmanned aircraft configured to deploy water or other fire-mitigating agent toward a target for mitigating an actual or potential fire event;

“fire-mitigating vehicle” means an unmanned vehicle, such as a truck, configured to store and deploy a fire-mitigating agent toward a target for mitigating an actual or potential fire event;

“surveillance drone” means an unmanned aircraft configured to follow a flightpath or to be remotely piloted via wireless communications about an infrastructure or protected area for and comprising an on-board fire-associated risk surveillance asset for purposes of discovering and detecting a fire-associated risk event;

“unmanned aircraft” means any aircraft operating or designed to operate autonomously or to be piloted remotely without a pilot on board;

“unmanned vehicle” means any vehicle configured to transport on land and operating or designed to operate autonomously or to be driven remotely without a driver on board; and

“water spraying system” means any system providing a source of water to a network of installed valves and spray nozzles within or adjacent to a protected infrastructure or protected area, the activation of which results in the spraying of water or a fire-mitigating agent on, beneath, or adjacent to the protected infrastructure or protected area.

Other terms not explicitly defined herein shall be interpreted in accordance with their plain and ordinary meaning as would be appreciated by one having skill in the art.

### GENERAL DESCRIPTION OF EMBODIMENTS

In one embodiment, an autonomous firefighting system is disclosed. The autonomous comprises one or more fire-mitigating trucks, a thermal camera coupled to a vehicle via a scissor lift, and a controller communicatively coupled to the thermal camera. The controller is configured to detect a fire-associated risk event with the thermal camera and send instructions and deploy the one or more fire-mitigating trucks for mitigating actual or potential damage associated with the detected fire-associated risk events.

In some embodiments, the autonomous firefighting system may further comprise one or more fire-mitigating drones configured to receive instructions from the controller and further configured to deploy for mitigating actual or potential damage associated with the detected fire-associated risk events.

In some embodiments the autonomous firefighting system may further comprise one or more fire-mitigating drones which are disposed on one or more drone nests prior to each of the one or more fire-mitigating drones receiving instructions from the controller.

In some embodiments the one or more drone nests may be configured to electrically charge the one or more fire-mitigating drones.

In some embodiments the one or more fire-mitigating drones may be disposed on one or more drone trucks prior to each of the one or more fire-mitigating drones receiving instructions from the controller.

In some embodiments of the autonomous firefighting system, the one or more drone trucks may be configured to electrically charge the one or more fire-mitigating drones.

In another embodiment, an autonomous firefighting system is disclosed. The autonomous firefighting system comprises one or more fire-mitigating assets, one or more fire-associated risk surveillance assets, and a controller configured to detect fire-associated risk events with the one or more fire-associated risk surveillance assets, and deploy the one or more fire-mitigating assets for mitigating actual or potential damage associated with the detected fire-associated risk events.

In some embodiments the one or more fire-mitigating assets may comprise a fire-mitigating drone, a water spraying system, a fire-mitigating truck, or a combination thereof.

In some embodiments the fire-mitigating drone may comprise a laser source configured to emit laser energy for altering a physical object.

In some embodiments, the fire-mitigating drone may comprise an infrared thermal imaging camera.

In some embodiments, the water spraying system may comprise one or more reservoirs and a series of valves coupled to the one or more reservoirs, wherein each valve in the series of valves may be controllable by the controller. The one or more reservoirs may each comprise a fire-mitigating agent.

In some embodiments each of the one or more reservoirs may comprise an elevation greater than five feet above the series of valves.

In some embodiments the one or more fire-associated risk surveillance assets may comprise a surveillance drone, a sensor, a thermal camera or a combination thereof.

In some embodiments the surveillance drone may comprise a temperature sensor, an infrared sensor, a camera, or a combination thereof.

In some embodiments the controller comprises a fixed location controller. In other embodiments the controller comprises a mobile location controller.

In some embodiments the sensor may comprise a wire tension sensor, an ice costing sensor, a tension clamp sensor, a smoke sensor, an infrared sensor, or a combination thereof.

In some embodiments the sensor may be configured to couple to one of an electric tower or power line associated therewith.

In some embodiments the thermal camera may be coupled to a pole.

In some embodiments the pole may be configured to expand and collapse.

### General Example

In a general example, an autonomous firefighting system includes a controller coupled to one or more unmanned aircraft and/or a water spraying system, and the controller is further coupled to one or more fire-associated risk surveillance assets (FARSAs), wherein the controller is adapted to detect a fire-associated risk event, and upon detection thereof, the controller is configured to deploy at least one of the one or more unmanned aircraft for mitigating risk associated with the fire-associated risk event.

By “coupled”, it is meant the controller is in communication with the respective componentry, for example, via wireless communication, and optionally via the ISM band, though cellular communication bands, satellite communication bands and the like may be similarly implemented.

In the general example, the controller may comprise a fixed location controller, such as a computer installed in a building (“fixed control center”), or a mobile location controller, such as a computer installed in a vehicle or aircraft or integrated with a portable electronic device (“portable control center”), and may be either central or distributed. The controller is generally a computer processing unit coupled to each of the one or more unmanned aircraft, vehicles, and/or the water spraying system, and the one or more FARSAs, via a network connection.

At least one of the one or more unmanned aircraft (or “drones”) or one of the FARSAs may comprise a surveillance drone that is configured to fly along a flightpath in search of a fire-associate risk event. In this regard, the surveillance drone may comprise, for example and not limitation, at least one on-board sensor for detecting temperature, infrared, or cameras and/or sensors for identifying objects such as debris on power lines. The surveillance drone may be programmed to fly along a pre-determined flightpath, or to be manually directed by a remote human pilot along a spontaneous discerned flightpath. The surveillance drone may be used to aid in the identification of objects associated with a fire-associated risk event.

One of the FARSAs may comprise a thermal camera, such as an infrared camera. Such a thermal camera can be coupled to the surveillance drone, or installed remotely (ex: on a post), and configured to monitor a subject space or portion of the infrastructure within a protected area. The thermal camera may be configured to monitor ground temperature or temperature at a surface of the infrastructure, and upon the controller coupled to the thermal camera detecting a temperature that is indicative of a fire, the controller may deploy one or more unmanned aircraft or other firefighting assets, for example, a water spraying system. To this end, software associated with the controller, which may comprise artificial intelligence, may prepare and send command instructions to one or more unmanned aircraft of the system via the network connection, thereby enabling the unmanned aircraft to mitigate the fire-associated risk event, or additionally/alternatively may activate the water spraying system in at least a portion of the protected area. For example, upon receiving such instructions from the controller, the one or more unmanned aircraft may deploy water or a fire-retardant composition to the fire. The unmanned aircraft may optionally enhance the action of fighting fire by making use of an on-board FARSA, such as a thermal camera or infrared sensor, to identify and target the fire event.

Other FARSAs for integration with the system may comprise a power line-based sensor or remote-based sensors, such as, for example, a temperature sensor, a wire tension sensor, ice costing sensor (a sensor that detects ice formation on power lines), a tension clamp sensor, a weather sensor, a camera other than thermal imaging camera, or other sensor for detecting temperature, infrared, humidity, mass, vibration, and the like. One or more of these FARSAs may be implemented in the system by installing on towers, poles, or on unmanned aircraft.

The autonomous firefighting system may comprise a water spraying system, for example and not limitation, a water spraying system comprising a water reservoir (or “water tank”) and a network of piping for routing the water from within the water reservoir to a distal point where a valve and/or spray nozzle are disposed, thereby enabling the spray of water or other fire-mitigating agent. In some embodiments, a tank may not be required, for example, where a pressurized water source is available. Each valve of a series of valves associated with the water spraying system can be controlled by the controller of the autonomous firefighting system, such that upon detecting a fire event in a first area, one or more valves and spray nozzle(s) can become activated by the controller for spraying water at the targeted fire event in the first area, whereas valves and nozzles in a second or other area may remain inactivated (closed). In a preferred embodiment, the water reservoir should be at least five feet in elevation above the piping, valve(s) and spray nozzle(s) of the water spraying system for providing sufficient pressure to distribute an effective spray pattern. Additionally, in the preferred embodiment, at least the spray nozzle(s) of the water spraying system are directly beneath, or adjacent to power lines or infrastructure of the protected area.

In an embodiment, upon detecting fire, elevated temperature, or other user-specified event of the fire-associated risk events, the water spraying system is activated by the controller to open valve(s) and release spray to the protected area, wherein the spray may comprise water or other fire-mitigating agent, such as a fire-retardant composition.

Other unmanned aircraft may comprise fire-mitigating drones, for example, a drone configured to expel water or other fire-mitigating agent, such as a fire-retardant composition.

In other embodiments, the drone may additionally or alternatively comprise a laser source configured to emit laser energy for altering a physical object, such as cutting debris.

In sum, the fire-associated risk surveillance assets (FARSAs) may function with the controller coupled therewith to detect a fire or object associated with high risk of fire (for example, debris on a power line), and upon detection, the controller sends instructions to one or more unmanned aircraft and/or a water spraying system for fighting fire or eliminating the object debris for mitigating risk of fire damage to an infrastructure, such as a building or power lines, or other protected space.

In embodiments with a water spraying system, the valves of the water spraying system can be controlled via wireless technology, thus the valves can be “smart” water valves.

A drone may be equipped to comprise a laser source, wherein the laser source comprises sufficient power to cut or alter the physical state of an object. In this regard, the laser configured drone may be used to remove debris from a powerline or other protected structure by removing the debris via laser energy.

A protected area may preferably include an area comprising power lines and associated poles and/or towers, or may include buildings, open land and the like.

A thermal camera may comprise one or more features for use as a fire-associated risk surveillance asset such as an ability to capture high quality images in dim light environment or through barriers such as fog. The thermal camera may also comprise a gimbal or other means of achieving a 360-degree view. Other features appreciated by one having skill in the art may also be implemented.

In any embodiment, whether explicit in the disclosure or otherwise, any single feature from one illustrated or explicit embodiment may be similarly implemented with another feature or combination of features independently disclosed in one or more other embodiments, such that the features may be interchanged to create one of a myriad of possible embodiments for practicing the invention of an autonomous firefighting system for mitigating fire damage within or adjacent to a protected area.

Thus, the following examples are provided to illustrate various embodiments of the invention and should not be construed as limiting of the myriad of possible embodiments of the invention that may be practiced.

### Example 1—FARSA & Water Spraying System

An autonomous firefighting system is installed and configured to protect power lines in a remote location. The power lines include a plurality of towers and/or poles, each of which suspending power lines above ground. Debris, such as flying paper, fabric or other debris can catch fire upon contact with the power lines, and possibly spread the fire to ground cover should the debris fall, thereby presenting a risk of fire damage. The event of debris contacting power lines is therefore a fire-associated risk event. In this example, debris does land on the power lines. Fortunately, the autonomous firefighting system is installed, and comprises at least one fire-associated risk surveillance asset (FARSA) and a water spraying system. For purposes of this example, the FARSA comprises a thermal camera mounted on a pole or tower, and can be mounted on a pole or tower of the power lines infrastructure as in this example, or otherwise mounted on a remote pole or tower not connected to the power lines, but adjacent therewith, enabling the thermal camera to monitor the power lines for thermal energy indicating fire. Upon the debris contacting the power lines, the debris catches fire and falls to ground, which fire is detected by the thermal camera and controller by way of software. The software may include artificial intelligence, such as machine learning, for improving, over time, detection of a fire-associated risk event. Here, upon detecting the debris-fire on the power lines or on ground, controller sends instructions over a network connection to the water spraying system, the instructions including sector or location information for opening one or more valve(s) of the water spraying system in the sector or location and deploying water and/or a fire-mitigating agent in the form of spray onto the surrounding area. Upon extinguishing the fire, as determined by the thermal camera and controller (example, temperature is normalized), the controller is configured to send instructions to the one or more valve(s) of the water spraying system for closing the valve(s) and ceasing deployment of the spray. Thus, an autonomous firefighting system may comprise one or more FARSAs and a water spraying system coupled to a controller, wherein the controller is configured to detect a fire using the FARSAs and subsequently deploy the water spraying system to mitigate the fire.

### Example 2—FARSA & Water Spraying System Plus Fire-Mitigating Drone

In another example, the autonomous firefighting system of Example 1 further comprises one or more unmanned aircraft, wherein at least one of the unmanned aircraft is configured to deploy water and/or a fire-mitigating agent, such as, without limitation, a fire-retardant agent. Here, the unmanned aircraft receives instructions from the controller with information for locating the fire. Optionally, the unmanned aircraft may include an on-board sensor, such as a drone-mounted thermal energy camera, for locating and targeting the fire. Once in proximity to the fire, the unmanned aircraft deploys the water or other fire-mitigating agent for extinguishing the fire. Here, one or more drones may be deployed for fighting the fire.

### Example 3—FARSA Surveillance Drone & Water Spraying System

In another example, an autonomous firefighting system comprises at least one fire-associated risk surveillance asset (FARSA) and a water spraying system, wherein the FARSA comprises a surveillance drone configured to patrol at least a portion of a protected area. The surveillance drone may patrol either autonomously, with a pre-programmed flightpath, or may patrol with human direction, with a spontaneous flightpath derived from human involvement. The surveillance drone may comprise one or more FARSAs for detecting a fire-associated risk event, such as an object contacting a power line, elevated temperature of power line components, or actual fire, such as may be generated by lightning or by failing components on power lines, or other similar event as would be appreciated by one with skill in the art. Here, the surveillance drone and controller are configured to detect a fire-associated risk event, and deploy the water spraying system to reduce the likelihood of field vegetation or structure catching fire in the protected area, for example, should sparks travel from a failing powerline component.

### Example 4—FARSA & Fire-Mitigating Drone

In yet another example, an autonomous firefighting system comprises at least one fire-associated risk surveillance asset (FARSA) and one or more unmanned aircraft, wherein at least one of the unmanned aircraft comprises a fire-mitigating drone, for example, a drone configured to spray water or other fire-mitigating agent in a direction of a target. Here, the FARSA and controller are configured to detect a potential or actual fire event, and the controller is configured to deploy the fire-mitigating drone to extinguish the fire or dampen at least a portion of the protected area for mitigating risk of fire damage or damage severity.

Other embodiments not explicitly disclosed herein, including embodiments combining one or more features from the various embodiments described herein, will be appreciated by one having skill in the art.

### First Illustrated Embodiment

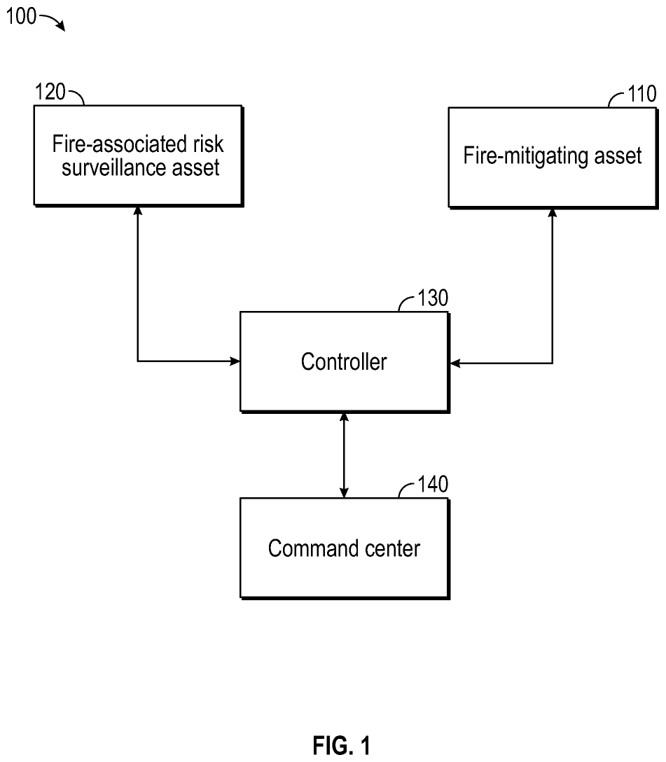

Now turning to the drawings, FIG. 1 shows a block diagram representation of an autonomous firefighting system (100) in accordance with a first illustrated embodiment. The autonomous firefighting system comprises a fire-associated risk surveillance asset (120), a fire-mitigating asset (110) and a command center (140) each coupled to a controller (130). The fire-associated risk surveillance asset is configured to detect a fire-associated risk event and send corresponding information to the controller. Upon receipt of said information, the controller is configured to deploy one or more fire-mitigating assets wherein each of the one or more fire-mitigating assets is configured to mitigate the fire-associated risk event.

The fire-associated risk surveillance asset (120) may comprise a plurality of sensors such as temperature sensors, wire tension sensors, ice costing sensors, tensing clamp sensors, weather sensors, thermal cameras, or the like. The fire-associated risk surveillance asset may be coupled to one or more surfaces to provide a plurality of data for the controller, for example and without limitation, to an electric tower, an unmanned aircraft, or a post. The post can be a static, monolithic piece tall enough to provide a sufficient view for the fire-associated risk surveillance asset. Or alternatively, the post may be configured to collapse and expand and may couple to the ground or a vehicle. It will be appreciated by one having skill in the art that an unmanned aircraft comprising a fire-associated risk surveillance asset is considered a surveillance drone. In addition to the fire-associated risk surveillance asset sending data to the controller (130) for processing and analysis of said data, the fire-associated risk surveillance asset is also configured to receive instructions from the controller. For example, the fire-associated risk surveillance asset may comprise a thermal camera coupled to a post, and may be configured to automatically rotate in a pre-defined manner regarding speed and direction. The controller may send instructions to the fire-associated risk surveillance asset to delineate from the pre-defined manner to focus on a particular area. These instructions may come automatically from the controller based on data already received, or may originate from the command center (140) for collecting additional data.

The fire-mitigating asset (110) may comprise various sub-systems designed to mitigate fire-associated risk events. Examples may include a fire-mitigating drone, a fire-mitigating truck, a water sprinkler system, or a combination thereof. In some embodiments, the fire-mitigating asset comprises one or more of a single type of fire-mitigating asset, for example, only fire-mitigating drones. In other embodiments, the fire-mitigating asset comprises a combination of different types of fire-mitigating assets, for example fire-mitigating drones and fire-mitigating trucks. Regardless of type, the fire-mitigating asset is configured to mitigate a fire-associated risk event. For example, if the fire-associated risk event is an actual fire, the fire-mitigating asset may be configured to expel water or other fire-mitigating agent to suppress and extinguish the fire. Expel in this regard may relate to expulsion similar to a fire hose at high pressure or some other means of releasing from the fire-mitigating asset the water and/or the fire-mitigating agent. In another example, if the fire-associated risk event comprises a wooden branch caught in a power line of an electric tower, the fire-mitigating asset may be configured to cut or burn the wooden branch prior to the wooden branch igniting and falling to the ground, thereby initiating a fire. The fire-mitigating asset should be located such that communication with the controller (130) is stable and response time to the fire-associated risk event is minimized. This may be achieved by drone nests adapted to store one or more fire-mitigating drones and further adapted to electrically charge the one or more fire-mitigating drones. In another embodiment, a vehicle is configured to store and transport the one or more fire-mitigating drones.

In some embodiments, the controller (130) is coupled to the fire-associated risk surveillance asset (120) via wireless communication. In other embodiments, the controller is coupled to the fire-associated risk surveillance asset electrically such that the controller is in close proximity to the fire-associated risk surveillance asset. One having skill in the art will appreciate that the controller should be located relative to the fire-associated risk surveillance asset, the fire-mitigating asset (110), and the command center (140) such that there is a high reliability of communication amongst all three. A robust communication with each can be achieved by wired communication, wireless communication, or a combination thereof. Generally, the controller is positioned near the fire-associated risk surveillance asset which is subsequently located near the fire-associated risk event given that the fire-associated risk surveillance asset is limited to an area where one or more sensors may detect said fire-associated risk event.

The command center (140) provides a plurality of data to a team tasked with monitoring and mitigating fire-associated risk events. In some embodiments, the command center may receive a live view via a camera associated with the fire-associated risk surveillance asset (120). A software program may also be utilized which is configured to set off an alarm when certain defined thresholds have been exceeded and recommend appropriate related responses for resolution. The command center may also be configured to receive instructions from a user, such as for controlling a fire-associated risk surveillance asset or fire-mitigating asset (110), and send said instructions to the controller (130) for execution. The command center may also collect data from the controller and provide reporting and predictions, in addition to a communication tool for all relevant parties. In some embodiments, the command center comprises the controller comprised therewith.

### Second Illustrated Embodiment

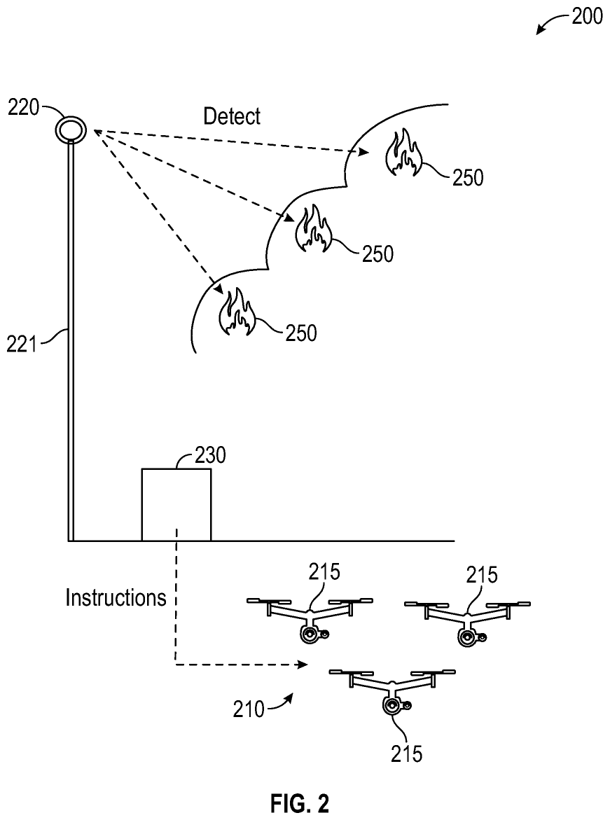

FIG. 2 shows an autonomous firefighting system (200) in accordance with a second illustrated embodiment. The autonomous firefighting system includes a fire-associated risk surveillance asset (220) having thermal camera mounted on a pole (221). The thermal camera is communicatively coupled to a controller (230), and a plurality of fire-mitigating assets (210) are each installed within or near a protected area at a home position, where the plurality of fire-mitigating assets comprises fire-mitigating drones (215). The controller is adapted to receive a plurality of images from the thermal camera and detect a fire-associated risk event (250), such as a fire, within the protected area. The controller is further adapted to send control signals (instructions) to the fire-mitigating drones for deployment to the detected fire for extinguishing the same or mitigating fire damage, after which the fire-mitigating drones may return to the home position.

The pole (221) comprises a height deemed sufficient to one having skill in the art such that a thermal camera coupled therewith is at a high enough elevation to survey a particular area. The pole may comprise a generally elongated structure erected from a ground surface or any other form appreciated by one having skill in the art to provide elevation for the thermal camera or other fire-associated risk surveillance assets (220) coupled therewith. As shown, the pole is coupled to a ground surface. In other embodiments, the pole is coupled to a vehicle. In some embodiments, the pole is configured to expand and collapse to varying heights by a scissor lift, a plurality of concentrically disposed portions, or the like.

### Third Illustrated Embodiment

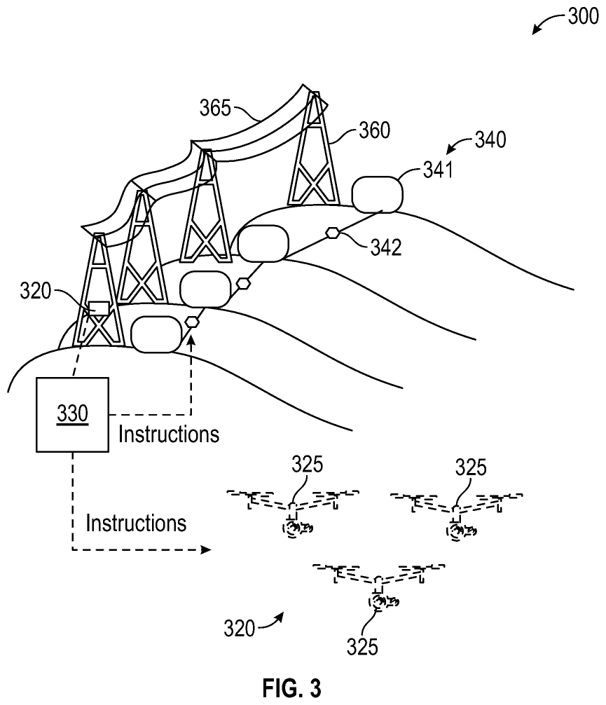

FIG. 3 shows an autonomous firefighting system (300) in accordance with a third illustrated embodiment. The autonomous firefighting system includes a fire-associated risk surveillance asset (320) positioned near a series of towers (360) and power lines (365) suspended therefrom, wherein adjacent to the powerlines is a water spraying system (340) including a series of water reservoirs (341) coupled to piping, valves (342) and nozzles. The water spraying system is configured to spray water or other fire-mitigating agent to cover a protected area beneath and adjacent to the power lines. Here, a controller (330) sends instructions to the valves to release the water or other fire-mitigating agent for extinguishing the detected fire.

As shown, the illustrated autonomous firefighting system (300) also comprises an additional fire-associated risk surveillance asset (320) wherein one or more surveillance drones (325) are configured to follow a flightpath or be remotely piloted via wireless communications of the controller (320) about an infrastructure or protected area for purposes of discovering and detecting a fire-associated risk event.

The water spraying system (340) may be actuated by the autonomous firefighting system (300) detecting a temperature, dryness, or a combination thereof such that the water spraying system can release water or other fire-mitigating agent proactively before a fire is detected.

### Fourth Illustrated Embodiment

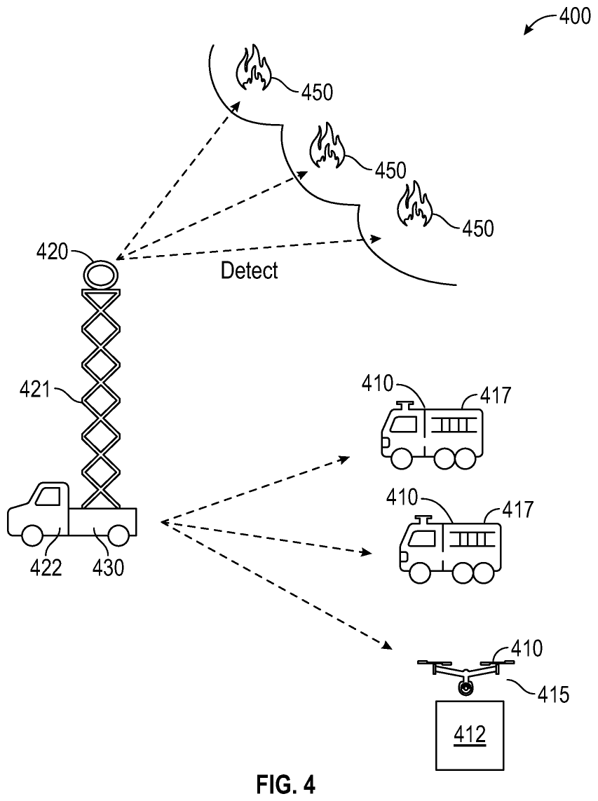

FIG. 4 shows an autonomous firefighting system (400) in accordance with a fourth illustrated embodiment. The autonomous firefighting system comprises a fire-associated risk surveillance asset (420) being a thermal camera coupled to a vehicle (422) via a scissor lift (421). The scissor lift is configured to raise and lower the thermal camera to an appropriate height for capturing images of a fire-associated risk event (450). The images are sent to a controller (430) which collects and processes the images and upon certain criteria may send instructions to one or more fire-mitigating assets (410) such as a fire-mitigating truck (417) and/or fire-mitigating drone (415), wherein upon receiving said instructions, the fire-mitigating trucks and/or drones are adapted to travel toward the fire-associated risk event.

As shown, the controller (430) is coupled electrically with the fire-associated risk surveillance asset (420) which allows the vehicle (422) to move in different areas for surveillance. Portability of the fire-associated risk surveillance asset and controller allows for a large area to be covered without requiring a plurality of stationary systems. In other embodiments, the controller is wireless coupled to the fire-associated risk surveillance asset. In some embodiments, one or more surveillance drones may comprise the controller instead of the vehicle.

The fire-mitigating drone (415) as shown is stationed at a drone nest (412) when not deployed by the controller (430). The drone nest is configured to store one or more drones and provide a charging capability thereto. In other embodiments, the one or more fire-mitigating drones may be located on a drone truck or may be coupled to the fire-mitigating trucks (417).

### FEATURE LIST

autonomous firefighting system (100; 200; 300; 400)
fire-mitigating asset (110; 210; 310; 410)
fire-associated risk surveillance asset (120; 220; 320; 420)
controller (130; 230; 330; 430)
command center (140)
fire-associated risk event (150; 250; 450)
fire-mitigating drone (215; 415)
pole (221)
water spraying system (311)
water reservoir (312)
piping (313)
valves (314)
surveillance drone (325)
tower (360)
power lines (365)
drone nest (416)
fire-mitigating truck (417)
scissor lift (421)
vehicle (422)

What is claimed is:

1. An autonomous firefighting system, comprising:
one or more fire-mitigating trucks;
a thermal camera coupled to a vehicle via a scissor lift; and
a controller communicatively coupled to the thermal camera,
the controller configured to detect a fire-associated risk event with the thermal camera and send instructions and deploy the one or more fire-mitigating trucks for mitigating actual or potential damage associated with the detected fire-associated risk events.

2. The autonomous firefighting system of claim 1, further comprising one or more fire-mitigating drones configured to receive instructions from the controller and further configured to deploy for mitigating actual or potential damage associated with the detected fire-associated risk events.

3. The autonomous firefighting system of claim 2, wherein the one or more fire-mitigating drones are disposed on one or more drone nests prior to each of the one or more fire-mitigating drones receiving instructions from the controller.

4. The autonomous firefighting system of claim 3, wherein the one or more drone nests is configured to electrically charge the one or more fire-mitigating drones.

5. The autonomous firefighting system of claim 2, wherein the one or more fire-mitigating drones are disposed on one or more drone trucks prior to each of the one or more fire-mitigating drones receiving instructions from the controller.

6. The autonomous firefighting system of claim 5, wherein the one or more drone trucks is configured to electrically charge the one or more fire-mitigating drones.

7. An autonomous firefighting system, comprising:
one or more fire-mitigating assets;
one or more fire-associated risk surveillance assets; and
a controller configured to detect fire-associated risk events with the one or more fire-associated risk surveillance assets, and deploy the one or more fire-mitigating assets for mitigating actual or potential damage associated with the detected fire-associated risk events.

8. The autonomous firefighting system of claim 7, wherein the one or more fire-mitigating assets comprises a fire-mitigating drone, a water spraying system, a fire-mitigating truck, or a combination thereof.

9. The autonomous firefighting system of claim 8, wherein the fire-mitigating drone comprises a laser source configured to emit laser energy for altering a physical object.

10. The autonomous firefighting system of claim 8, wherein the fire-mitigating drone comprises an infrared thermal imaging camera.

11. The autonomous firefighting system of claim 8, wherein the water spraying system comprises:
one or more reservoirs,
the one or more reservoirs each comprise a fire-mitigating agent; and
a series of valves coupled to the one or more reservoirs;
wherein each valve in the series of valves is controllable by the controller.

12. The autonomous firefighting system of claim 11, wherein each of the one or more reservoirs comprises an elevation greater than five feet above the series of valves.

13. The autonomous firefighting system of claim 7, wherein the one or more fire-associated risk surveillance assets comprises a surveillance drone, a sensor, a thermal camera or a combination thereof.

14. The autonomous firefighting system of claim 13, wherein the surveillance drone comprises a temperature sensor, an infrared sensor, a camera, or a combination thereof.

15. The autonomous firefighting system of claim 7, wherein the controller comprises a fixed location controller.

16. The autonomous firefighting system of claim 7, wherein the controller comprises a mobile location controller.

17. The autonomous firefighting system of claim 13, wherein the sensor comprises a wire tension sensor, an ice costing sensor, a tension clamp sensor, a smoke sensor, an infrared sensor, or a combination thereof.

18. The autonomous firefighting system of claim 17, wherein the sensor is configured to couple to one of an electric tower or power line associated therewith.

19. The autonomous firefighting system of claim 13, wherein the thermal camera is coupled to a pole.

20. The autonomous firefighting system of claim 19, wherein the pole is configured to expand and collapse.
